(19) United States
(12) Patent Application Publication
(10) Pub. No.: US 2017/0011309 A1
(43) Pub. Date: Jan. 12, 2017

(54) SYSTEM AND METHOD FOR LAYERED, VECTOR CLUSTER PATTERN WITH TRIM

(71) Applicant: IPVIVE, INC., Oakland, CA (US)

(72) Inventors: Greg Tsutaoka, Oakland, CA (US); Nathaniel J. Thurston, Oakland, CA (US); Olena Tashkevych, Oakland, CA (US)

(73) Assignee: IPVIVE, INC., Oakland, CA (US)

(21) Appl. No.: 15/204,905

(22) Filed: Jul. 7, 2016

Related U.S. Application Data
(60) Provisional application No. 62/189,655, filed on Jul. 7, 2015.

(51) Int. Cl. G06N 99/00

(52) U.S. Cl. CPC G06N 99/005

(57) ABSTRACT

A method and apparatus to comprehend situations for an Emotionally Intelligent Technology-Aided Decision System, and more particularly, with an improved auto regression architecture and method for sporadic, heterogeneous, multimodal, unlabeled, unstructured, sequential data. Auto-regression architecture is used to abstract unlabeled, data with a layered approach involving co-occurrence matrix generation, vectoring, clustering, pattern finding, and trimming techniques combined together.

### CROSS-REFERENCE TO RELATED APPLICATIONS

This application claims the benefit of U.S. Provisional Patent Application No. 62/189,655, filed on Jul. 7, 2015, which is incorporated by reference in its entirety for all purposes.

### FIELD OF THE INVENTION

The present invention relates generally to a method and apparatus to comprehend situations for an Emotionally Intelligent Technology-Aided Decision System, and more particularly, to an improved auto-regression architecture and a method for sporadic, heterogeneous, multimodal, unlabeled, unstructured, sequential data. For example, using the principles of the present invention, facial expressions can be sensed, characterized as a numerical vector, clustered with similar vectorized voice expressions, interpreted and then used as the basis for appropriate action.

### BACKGROUND OF THE INVENTION

Over the past 60 years, the deluge of data has grown, continuing the demand and need for more powerful decision support systems. During this time, task specific artificial intelligence methods have been developed to produce particular results. The continuing growth of the information industry creates the need for comprehension of sporadic, heterogeneous and multimodal data and results.

By the mid 1950′s, transistors had been around less than a decade, but scientists were envisioning how the new tools might improve human decision making. The collaborations of Herbert Simon, Allen Newell, Harold Guetzkow, Richard Cyert, James March, Marvin Minsky and John McCarthy produced early computer models of human cognition, the embryo of artificial intelligence (AI).

AI was intended both to help researchers understand how the brain makes decisions and to augment the decision making process for real people in real organizations. In the late 1960′s, decision support systems started showing up in large companies supporting the practical needs of managers. But while technology was improving operational decisions, it was still largely a basic tool.

In 1979, John Rockart published “Chief Executives Define Their Own Data Needs,” which helped launch “executive information systems,” a breed of technology specifically geared toward improving strategic decision making by giving top management data about key jobs the company must do well to succeed.

in the late 1980′s, a Gartner Group consultant coined the term “business intelligence” to describe systems that help decision makers throughout the organization understand the state of their company's world. At the same time, a growing concern with risk led companies to adopt simulation tools to assess competitive forces.

In the 1990′s, technology aided decision making found a new customer: customers themselves. The Internet, which companies hoped would give them more power to sell, instead gave consumers more power to choose from whom to buy.

Unlike executives making strategic decisions, emotions drive decisions for consumers. But in life, it is sometimes hard to notice, understand, and act upon emotions. In commerce, enterprises are not even really looking. There are 2.5+ quintillion bytes of data per day, and most of it is simple transactional record that is “machine learned”. This is at minimum an incomplete approach, and prioritizing the wrong thing.

The present invention overcomes the limitations of technology-aided decision systems by comprehending situations from sporadic, heterogeneous and multimodal data and results.

### SUMMARY OF THE INVENTION

Many algorithms and techniques are required by technology-aided decision making applications with data like video, audio, text, image, Internet of Things sensors (e.g. location, temperature, heart rate, pressure) etc. The present invention comprehends situations based on data and results including, but not limited to, verbal communications, nonverbal communications, biometric data, autonomic data, genetic data, environmental data, internet data, and licensed data.

The present invention improves upon prior art business intelligence and technology-aided decision making systems to comprehend who, what, when, where, feelings and why of a situation and/or pattern of situations over time. The present invention comprehends geometric representations of including, but not limited to, verbal communications, nonverbal communications, biometric data, autonomic data, genetic data, environmental data, internet data, and licensed data. The present invention is an auto-regression architecture and method. The present invention may be applied not only to the analysis of words and sentences but also to other forms of data, such as image-facial expressions, voice-emotions, video-context, medical (e.g., heart rates)-mental states, etc.

The present invention accomplishes its objectives by combining multiple layers of vectorization, clustering, pattern finding and trimming in a specific order and fashion that optimizes efficiency and accuracy. As a consequence, the present invention is capable of more accurate and efficient abstractions of unstructured sequential data than was possible with prior inventions.

### BRIEF DESCRIPTION OF THE DRAWINGS

FIG. 1 is an overview diagram of an emotionally intelligent technology-aided decision system.

FIG. 2 is a functional diagram of how an emotionally intelligent technology-aided decision system will empower users at work, at home, and at life.

FIG. 3 is a block diagram illustrating a computer system system incorporating present invention.

FIG. 4 is a flow diagram for a method of auto-regression architecture using layered, vector, cluster, pattern with trim processes.

FIG. 5 illustrates a single vector, cluster, pattern with trim layer.

FIG. 6 illustrates an example of tokens, token sequences and collections of tokens sequences.

FIG. 7 illustrates an example of token-to-vector mapping.

FIG. 8 is a flow diagram of generating co-occurrence matrix and token-to-vector mapping.

FIG. 9 is a flow diagram illustrating a process to generate a co-occurrence matrix.

FIGS. 10A-I are an example of clustering code.

FIG. 11 illustrates an example of clustering.

FIG. 12 illustrates an example of pattern detection using a co-occurrence matrix.

### DEFINITIONS

“Affect” is the experience of feeling or emotion. Affect is a key part of the process of an organism's interaction with stimuli. The word also refers sometimes to affect display, which is “a facial, vocal, or gestural behavior that serves as an indicator of affect”.

“Artificial Intelligence (AI)” is applied when a machine mimics “cognitive” functions that humans associate with other human minds, such as “learning” and “problem solving”.

“Associate” is applied when auto-regression is best fit to a geometric manifold boundary.

“Auto-regression” is a model used to capture linear and nonlinear interdependencies among multiple sporadic time series.

“Cluster” is the task of grouping a set of objects in such a way that objects in the same group (called a cluster) are more similar (in some sense or another) to each other than to those in other groups.

“Decide” is ability of a machine to perform general intelligent action.

“Emotional Intelligence” is the capacity to be aware of, control, and express one's emotions, and to handle interpersonal relationships judiciously and empathetically.

“Express” is computer program designed to simulate conversation with human users and device actions.

“Layered” is the multiple layers of auto-regression, which provides an advantage in comprehending abstracted pattern recognition problems.

“Intractable” is a problem that can be solved in theory (e.g., given large but finite time), but which, in practice, takes too long for the solution to be useful.

“Idiographic” is the effort to understand the meaning of contingent, unique, and often subjective phenomena.

“Multimodal Data” includes, but is not limited to, verbal communications, nonverbal communications, biometric data, autonomic data, genetic data, environmental data, internet data, and licensed data.

“Non-Verbal Communications” between people is communication through sending and receiving wordless clues. It includes the use of visual cues such as body language (kinesics), distance (proxemics) and physical environments/appearance, of voice (paralanguage) and of touch (haptics). It can also include chronemics (the use of time) and oculesics (eye contact and the actions of looking while talking and listening, frequency of glances, patterns of fixation, pupil dilation, and blink rate). Just as speech contains nonverbal elements known as paralanguage, including voice quality, rate, pitch, volume, and speaking style, as well as prosodic features such as rhythm, intonation, and stress, so written texts have nonverbal elements such as handwriting style, spatial arrangement of words, or the physical layout of a page. However, much of the study of nonverbal communication has focused on interaction between individuals, where it can be classified into three principal areas: environmental conditions where communication takes place, physical characteristics of the communicators, and behaviors of communicators during interaction.

“Pattern” is the ability to find simple patterns in data. Patterns of patterns are possible, and allow representation of more complex patterns than would be tractable otherwise.

“Recognize” is non-sentient computer intelligence or artificial intelligence that is focused on one narrow task.

“Technology-Aided Decision System” is a computer-based information system that supports consumer, business or organizational decision-making activities.

“Trim” is the elimination of redundant information or unlikely interpretations from active consideration.

“Unlabeled Data” is natural or human-created artifacts that can he obtained relatively easily from the world. Some examples of unlabeled data might include photos, audio recordings, videos, news articles, tweets, saliva for genetic data, etc. There is no “explanation” for each piece of unlabeled data, it just contains the data, and nothing else.

“Unstructured data” (or unstructured information) refers to information that either does not have a predefined data model or is not organized in a predefined manner. Unstructured information is typically text-heavy, but may contain data such as dates, numbers, and facts, as well.

“Verbal Communications” is the use of sounds and words to express oneself, especially in contrast to using gestures or mannerisms (nonverbal communication). An example of verbal communication is saying “No” when someone asks you to do something you do not want to do. Another example of verbal communication is accent as determined from phonetic patterns.

“Vector” is a numerical or geometric representation in one or more dimensions (e.g., characterizing an object or expression). A vector encodes information about a token (except for vectors that are input to the lowest layer). A vector may refer to the “concept” dimensions.

“Vector Sequence” is a collection of vectors, together with a start time and an end time for each vector. Note: vectors may overlap in time. A vector sequence may refers to the “temporal” dimension.

### DETAILED DESCRIPTION OF THE INVENTION

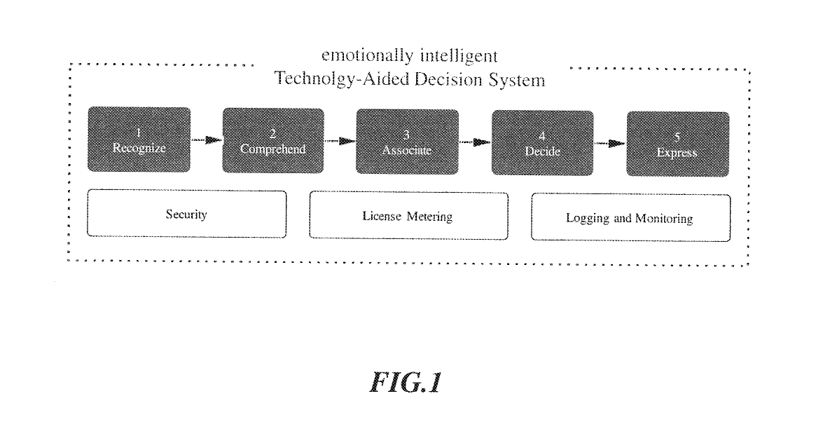

FIG. 1 illustrates the overall process in which a computer can perform an emotionally intelligent technology-aided decision system. The basic steps are recognition 1 by the computer of stimuli, processing 2 the recognized stimuli, associating 3 the processed stimuli with similar stimuli, deciding 4 the meaning of the processed stimuli and expressing 5 or communicating the decided meaning to a decision-maker. For example, a computer can be programmed using the present invention to detect various facial expressions, such as a furrowed brow. This facial expression will then be assigned a numerical vector representation. Afterwards, it will be associated with similar facial expressions having similar vector representations. By coordinating the processing of facial expressions with body language and words used by a person, the computer can interpret a person's thoughts and emotions. In this manner, the computer can act with emotional intelligence. If desired, the computer can then express to a decision-maker its interpretation of the person's thoughts and emotions. This could be useful, for example, during job interviews to give the decision-maker a deeper understanding of the candidate. If the computer determines that the candidate's facial expressions and body language contradicts their words, the computer could red flag this contradiction for the decision-maker.

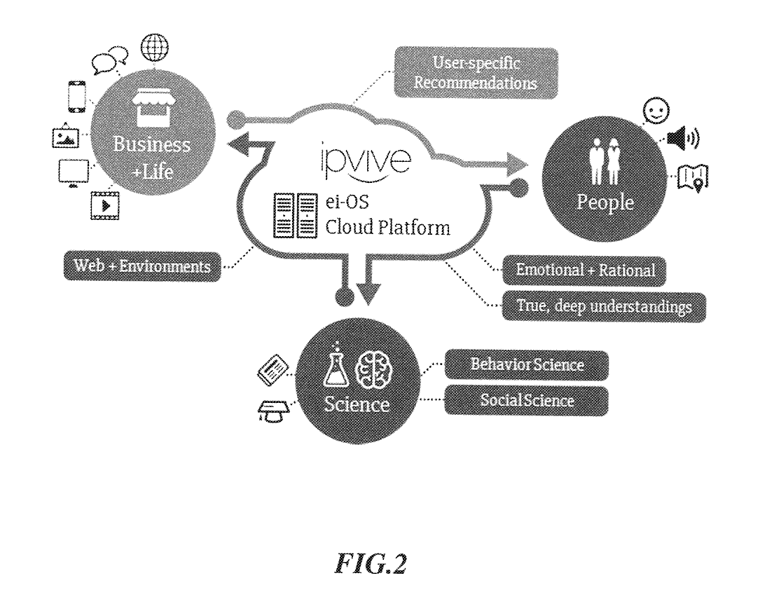

FIG. 2 illustrates a number of the potential applications of the computer technology of the present invention. As previously noted, the technology of the present invention can be used to better understand and interpret people. It could also be used to analyze and correlate scientific data. Further, it has many applications in business where sense needs to be made from a large mass of seemingly unrelated data.

### System Hardware

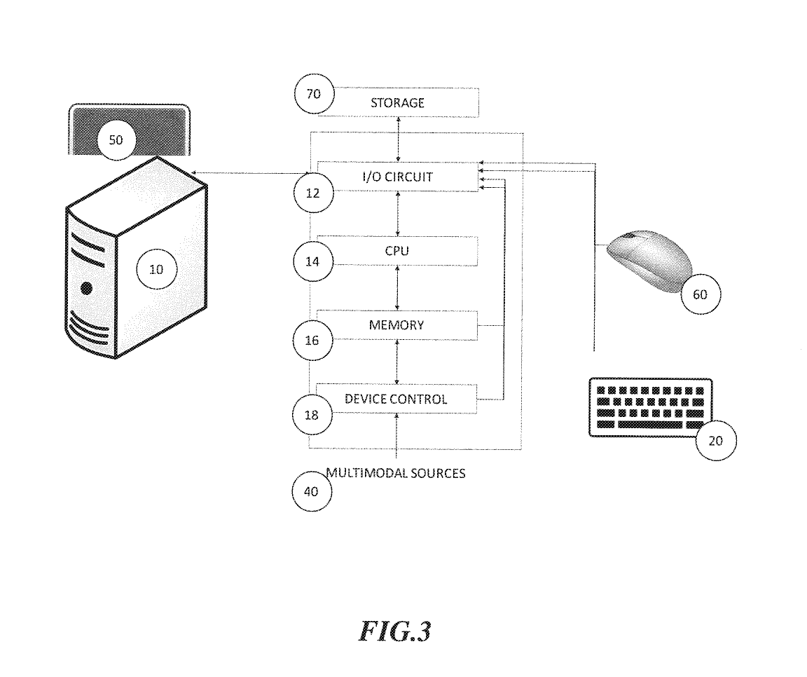

Referring now to FIG. 3, the hardware configuration of a preferred embodiment of the present invention is conceptually illustrated. As illustrated, the preferred emotionally intelligent technology-aided decision system includes a computer 10 which comprises four major components. The first of these is an input/output (I/O) circuit 12, which is used to communicate information in appropriately structured form to and from other portions of the computer 10. In addition, computer 10 includes a central processing unit (CPU) 14 coupled to the I/O circuit 12 and to a memory 16. These elements are those typically found in most computers and, in fact, computer 10 is intended to be representative of a broad category of data processing devices.

Also shown in FIG. 3 is a keyboard 20 for inputting data and commands into the computer through the I/O circuit 12. Similarly, multimodal sources, which may include peripheral sensors 30 such as a camera, heart rate monitor, blood pressure gauge, CD-ROM and the like are coupled to the I/O circuit 12 for providing additional inputting data. It will be appreciated that additional devices may be coupled to the computer 10 for storing data 70, such as buffer memory devices and the like. A device control 18 is coupled to both the memory 16 and the I/O circuit 12 to permit the computer to communicate with multimodal sources 40. The device control 18 controls operation of multimodal sources 40 to interface the multimodal sources 40 to the computer 10.

Also shown in FIG. 3 is a display monitor 50 coupled to the computer 10 through the I/O circuit 12. A cursor control device (commonly referred to as a “mouse”) 60 permits a user to select various command modes, modify graphic data, and input other data utilizing switches. More particularly, the cursor control device 60 permits a user to selectively position a cursor at any desired location on a display screen of the display monitor 50. It will be appreciated that the cursor control device 60 and the keyboard 20 are examples of a variety of input devices which may be utilized. Other input devices including, for example, trackballs, touch screens, data gloves, or other virtual reality devices may also be used in conjunction with the invention as disclosed herein.

### System Architecture

Layered Vector Cluster Pattern with Trim (LVCPT)

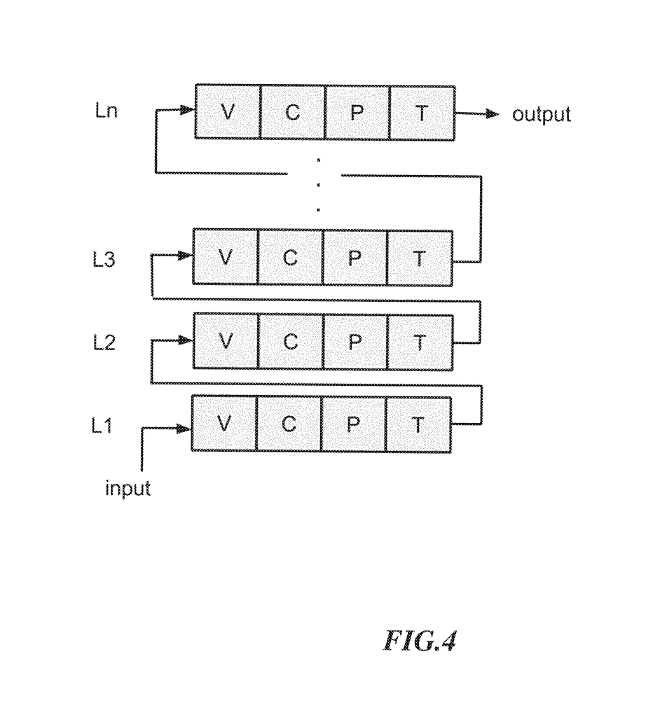

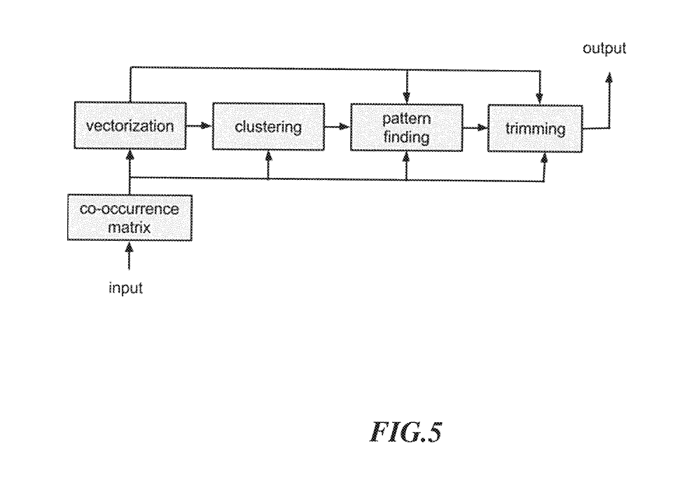

Referring to FIG. 4, the preferred auto-regression of the present invention is comprised of a series of layers of vectorization, clustering, pattern finding, and trimming (“LVCPT”). Unlabeled multimodal data enters the system at the (input) lowest layer and abstractions are generated as output, which is then received as input to the next higher layer. The abstractions are successively refined as they propagate through successive layers.

Referring again to FIG. 2, the versatility of layering vectorization, clustering, pattern finding, and trimming technology is demonstrated by the ability to have input from text documents, transcriptions of speech, short informal utterances (including slang and jargon), accent phonetics, emotions and states of mind, video, audio, saliva genetic data, and environmental measurements including, but not limited to, Global Positioning Satellite (GPS) information, climate conditions, and ambient noise.

The optimum number of layers of vectorization, clustering, pattern finding, and trimming in the architecture is dependent on the type and quality of the input and the demands of the output. Typically, adding additional layers will produce more abstract, more concise, better connected, but less detailed results. The versatility of the LVCPT product is demonstrated by the ability to use output from different layers, or several layers simultaneously.

FIG. 5 illustrates the architecture of a single layer of LVCPT. The sequence of steps is generation of the co-occurrence matrix, vectorization, clustering, pattern finding, and trimming. The input to a layer is a collection of token or vector sequences. The output is a collection of new token sequences with their corresponding vector representations. The output is in the same format as the input, allowing stacking of multiple layers on top of one-another.

In the preferred embodiment, particularly where words are used as the input, the generation of the co-occurrence matrix follows the mathematical approach described in GloVe [Jeffrey Pennington, Richard Socher, Christopher D. Manning, GloVe: Global Vectors for Word Representation; http://nlp.stanford.edu/projects/glove/glove.pdf]. The co-occurrence matrix is then used within the vectorization, clustering, pattern finding, and trimming steps.

### Generation of Co-occurrence Matrix and LVCPT

### 1.1. Input and Output

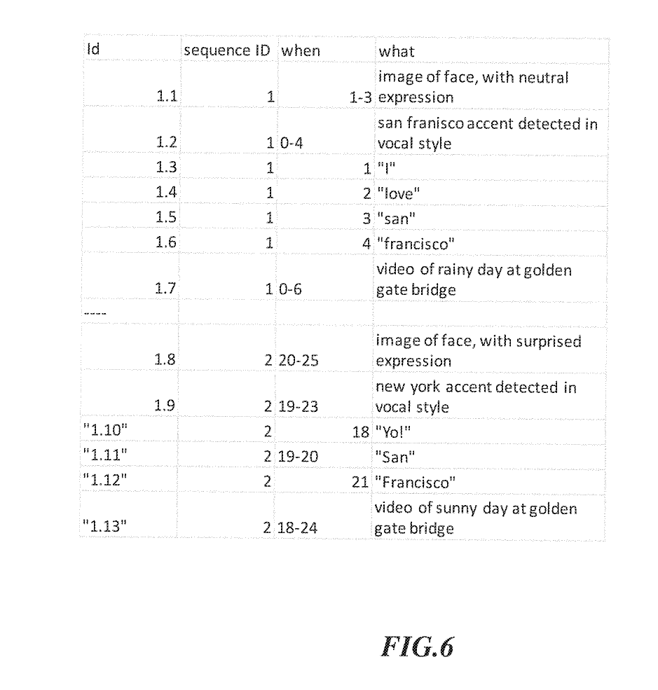

Referring to FIG. 6, multimodal data is used as the input. An input token is the basic unit of information. Each of the words, pictured objects (person or thing), accent phonetics or voice-emotions is considered a token. A token sequence is comprised of a series of tokens and, in this example, represents a single situation. A collection of token sequences is one or more token sequences. In this example, the collection contains two token sequences; one for each situations.

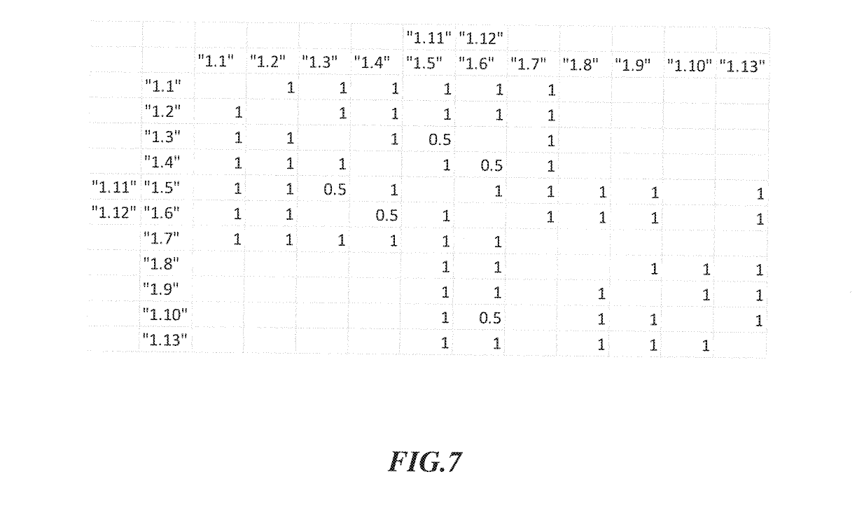

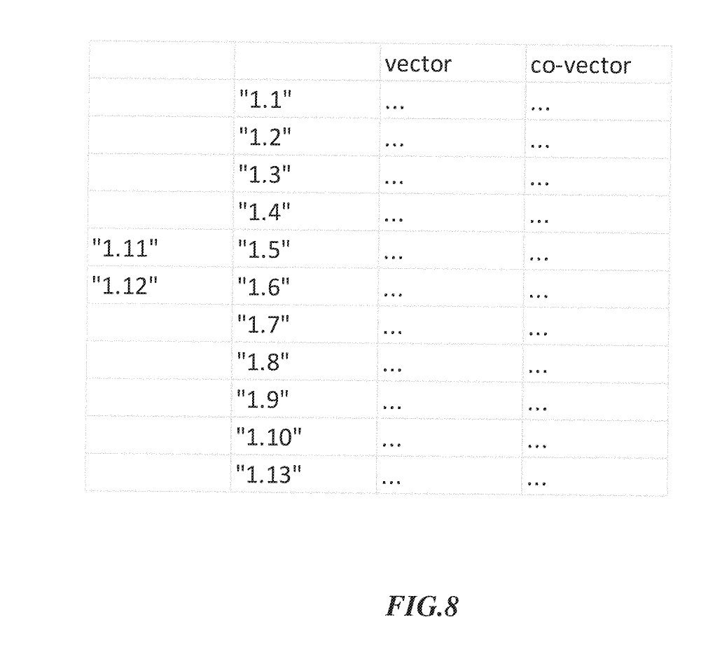

The output of vectorization is a token-to-vector mapping, as described below in section 1.3. FIG. 7 is an example of the output token-to-vector mapping corresponding to the collection of token sequences in FIG. 6. Each token from FIG. 6 is shown on the left-hand side of the token mapping. The corresponding vector for each token is shown on the right-hand side of the token mapping. There are three points to note:

1. The token “san” appears twice in FIG. 6 but only appears once as a token in FIG. 7. Only a single token to vector mapping will be produced for the entire input.

2. The name “San Francisco” corresponds to two separate tokens “san” and “francisco”. The fact that they frequently appear adjacent to each other is encoded in their corresponding vector values. Explicit recognition of the contraction isn't necessary for LVCPT, because it is possible to rejoin the compound as a pattern at a subsequent layer.

3. The explicit declaration of stop words, such as “the” and “is”, are not necessary for LVCPT as it is for other systems; these words will have low predictive value and will be blocked from the system in the trimming step.

### 1.2. Generation of Co-occurrence Matrix

FIG. 8 is a block diagram of the generation of a co-occurrence matrix and vectorization steps. A co-occurrence matrix captures, in matrix form, the sequential relationship between tokens separated by a designated number of tokens within a specified maximum window size.

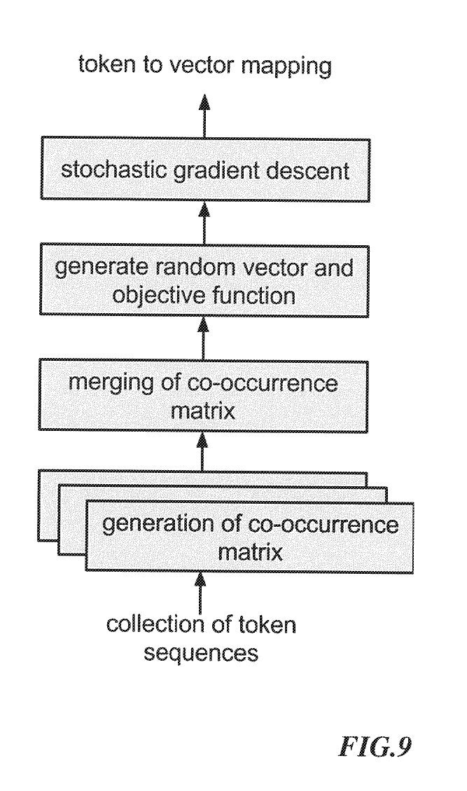

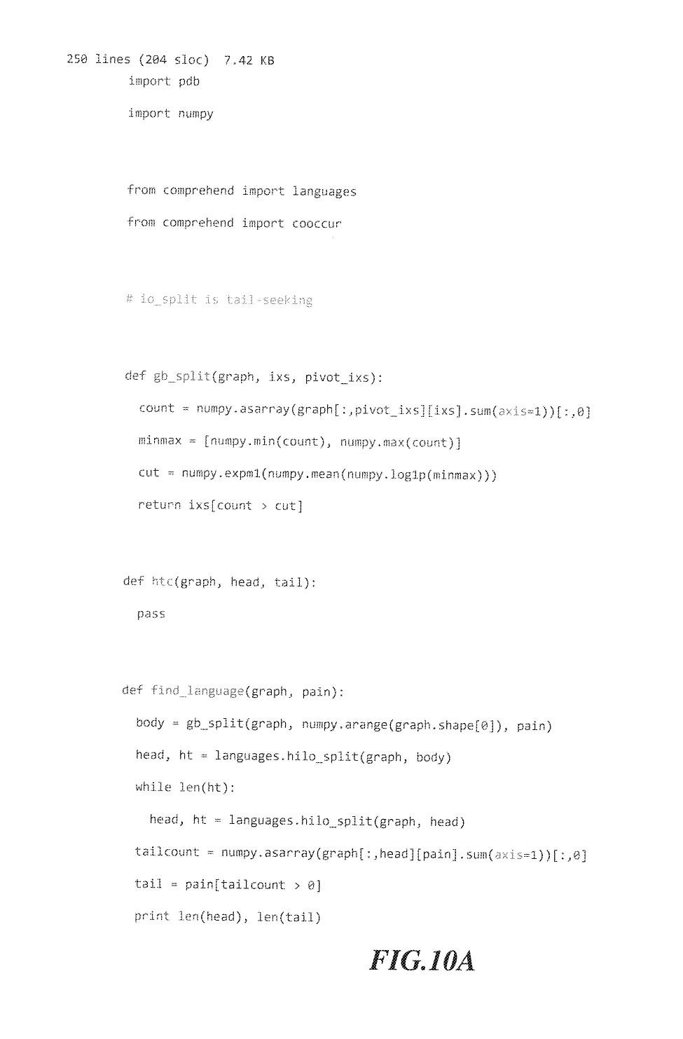

FIG. 9 shows the co-occurrence matrix for the corpus in FIG. 7 with window size 2. The window size determines the spacing limit on an association between two tokens. For example, a window of size<=1 in the token sequence would prevent an association between tokens “i” and “san” because their distance is 2, and a window of size>=3 would allow an association between tokens “i” and “francisco”. The weight associated with a given pair of co-occurring words is a function of their distance from each other; in the present example, that function is 1/distance. The preservation of token order results in the co-occurrence matrix being asymmetrical. Given distinct collections of token sequences, the generation of the corresponding co-occurrence matrix can be performed in parallel as denoted b the stacked boxes in FIG. 8.

After separate co-occurrence matrices are generated, they are preferably merged into one matrix. In most cases, the merged co-occurrence matrix will contain mostly entries with value 0, so it is more practical to use a sparse matrix representation to hold the co-occurrence matrix.

### 1.3 Generation of Vectors

The last two steps of vectorization generate an approximation of the single sparse matrix. The approximation is a reduced dimensional matrix, but still retains most of the information in the original sparse matrix, similar to principal component analysis. This is done by choosing a vector representation of the desired dimension, seeding it with pseudorandom values, choosing a function from the vector representations of a pair of tokens to a real number, and choosing a weighting function to assign relative importance to differences between the value predicted by the function and the actual value in the co-occurrence matrix. Together, these choices yield an objective function which computes an error from any vector mapping to tokens

After the objective function is defined, the actual minimization of the objective function is performed using stochastic gradient descent. Stochastic gradient descent is a commonly used technique in the field of machine learning. Our approach is not tied to this particular optimization technique and is adaptable to other optimization techniques. The resulting vectors are output as the token to vector mapping table.

### 1.4 Clustering

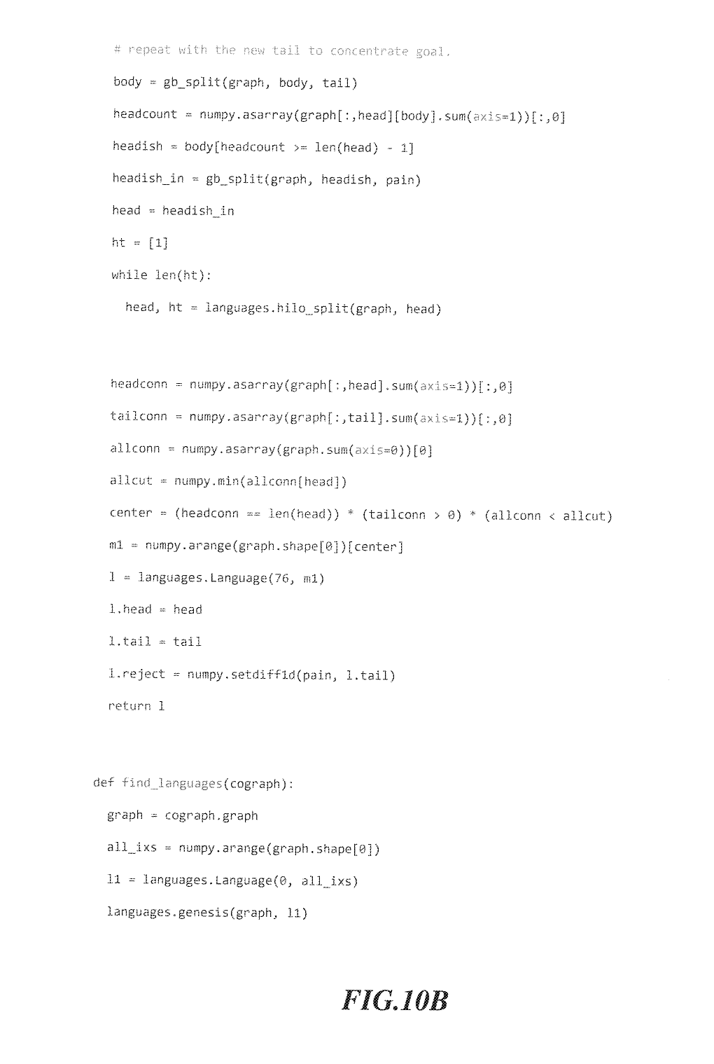

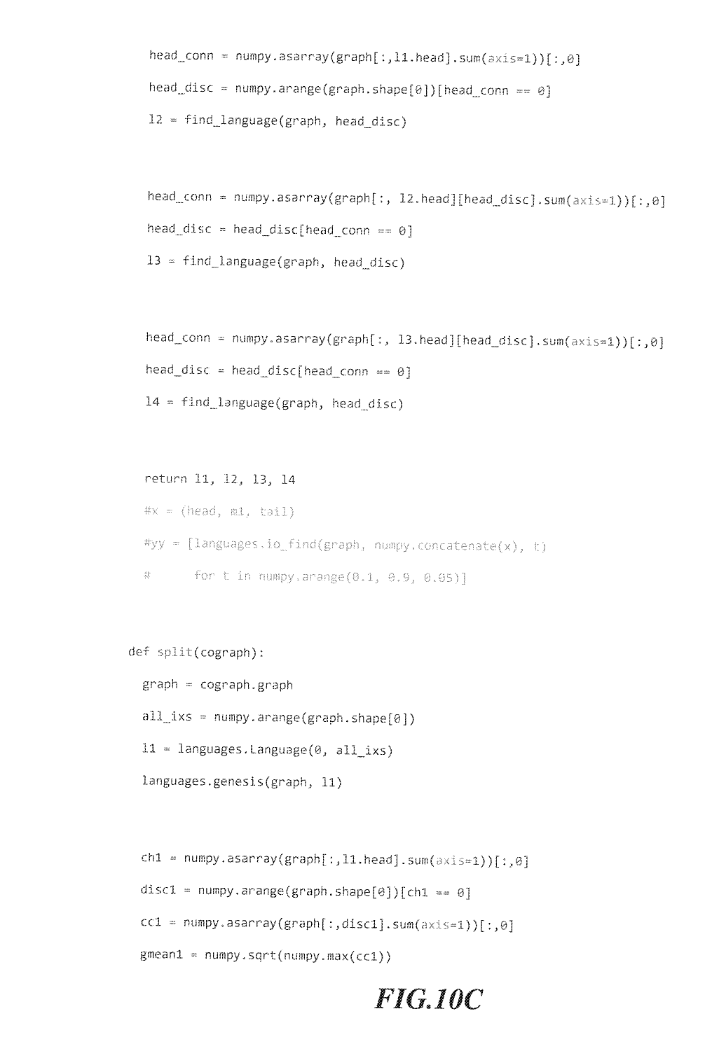

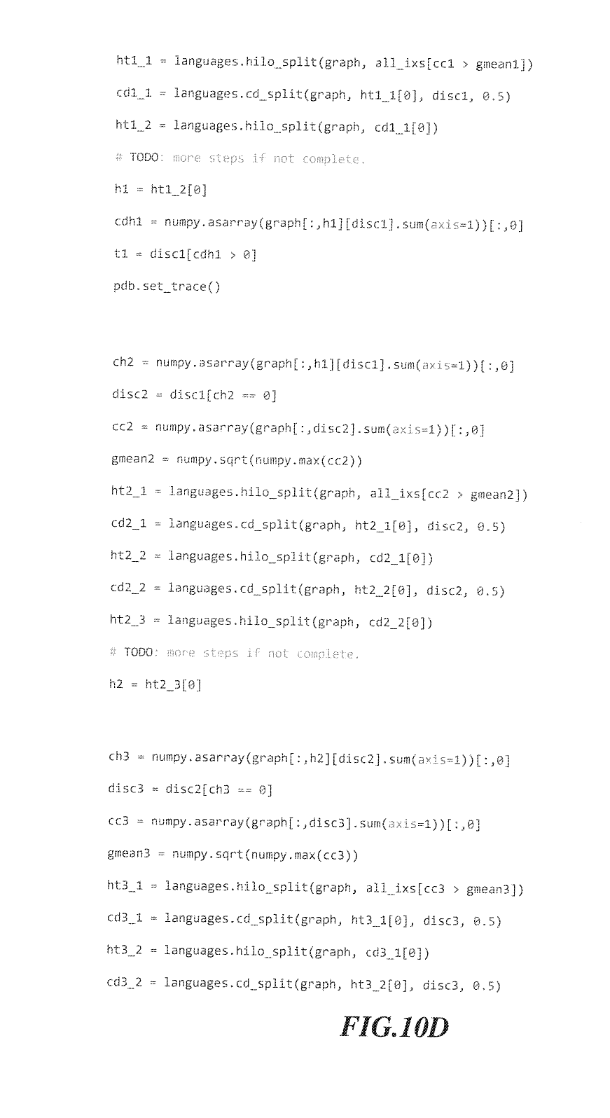

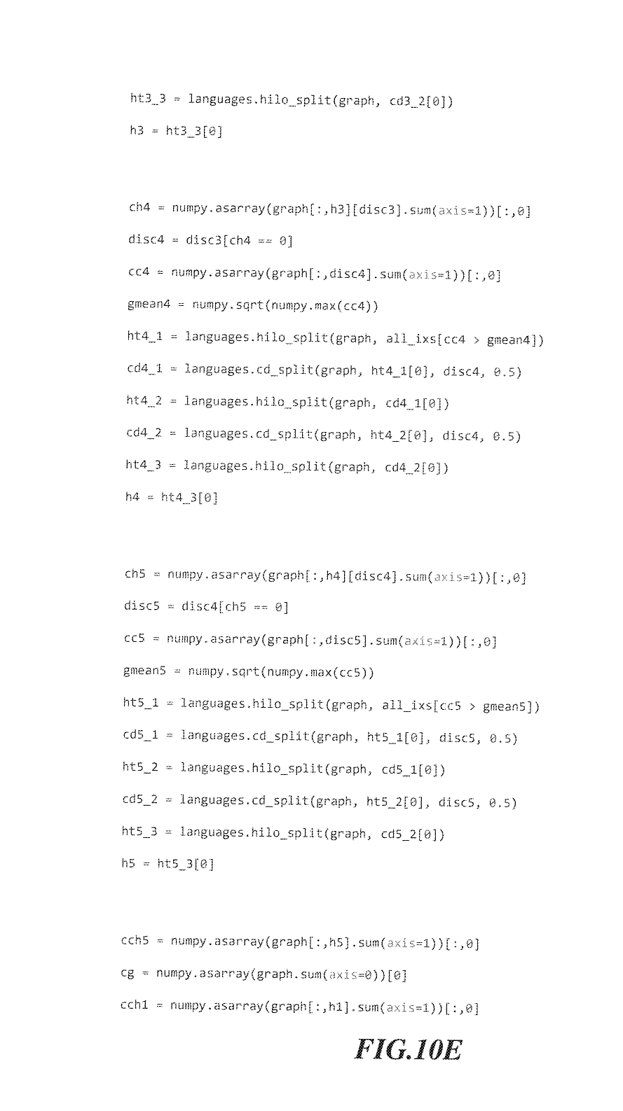

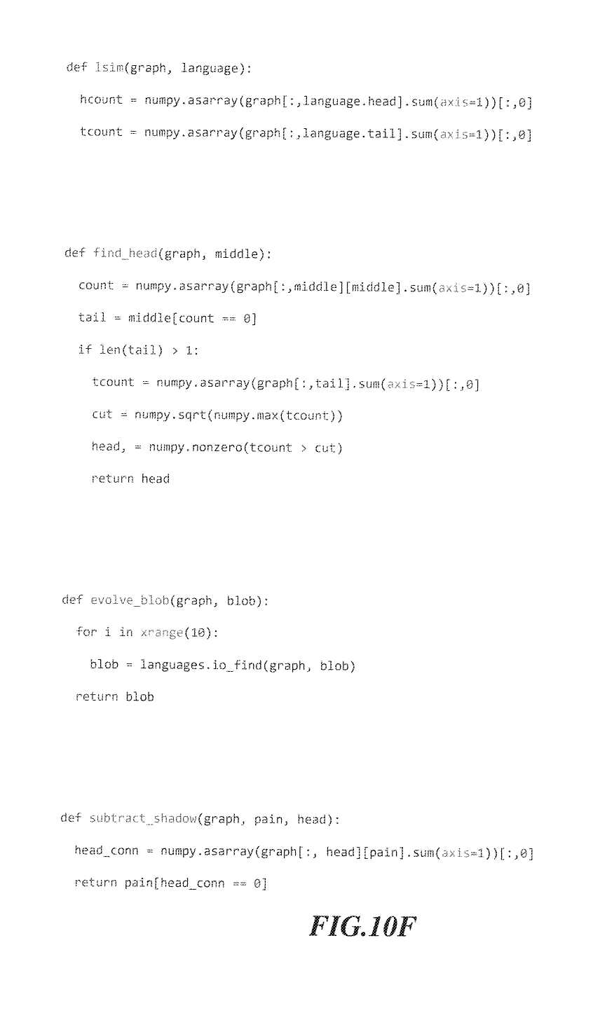

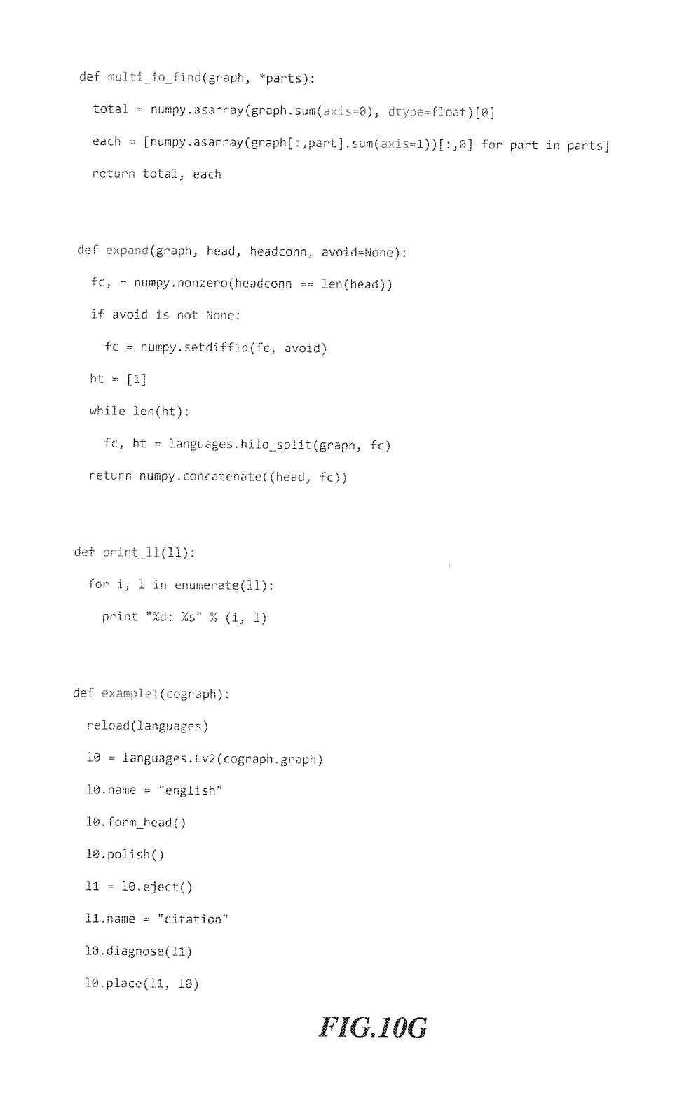

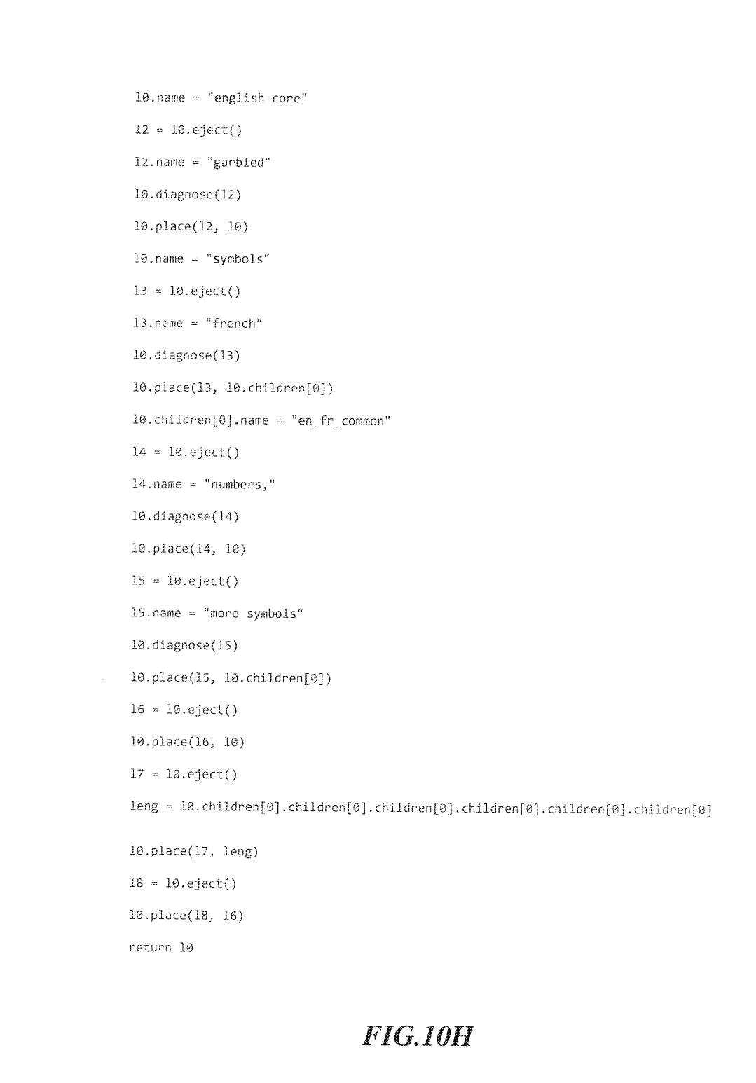

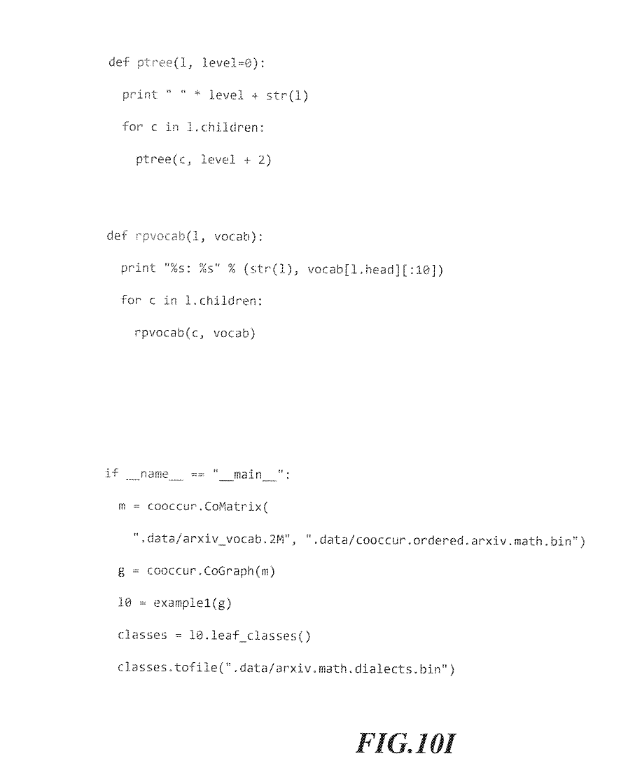

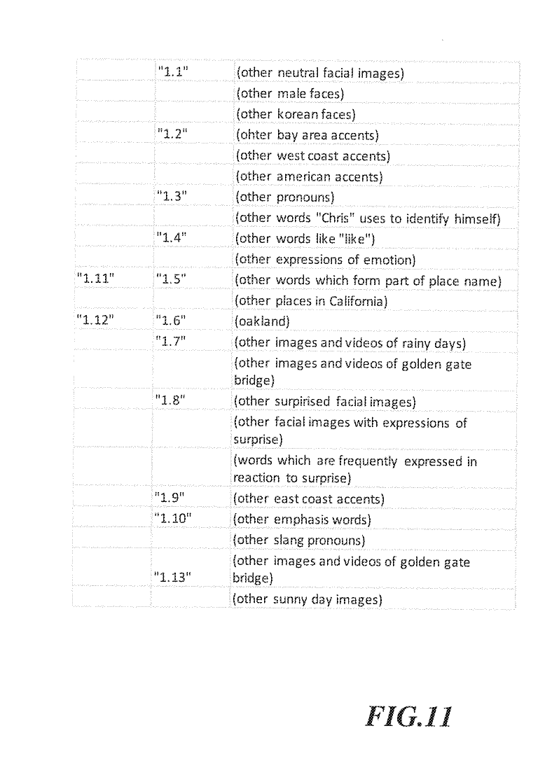

FIGS. 10A-I illustrates clustering code. FIG. 11 is a clustering example to compute associations between tokens by comparing their vector representations. Our innovation in clustering is generating overlapping rather than disjoint or hierarchical clusters. We generate overlapping clusters by merging the results from multiple executions of the clustering algorithm.

Clustering of vectors with similar meaning is based on a similarity metric between the distance of their values. The innovation on our clustering approach is the output is overlapping sets rather than disjoint sets as produced by existing clustering techniques (see, FIG. 10A-I).

FIG. 11 is an example of clustering for the collection of token sequences in FIG. 6. The token “san” resides in two clusters; “other words which form part of place name”, “other places in California”; “francisco” resides in one cluster “oakland”. The association of tokens across multiple clusters is accomplished by running the clustering algorithm multiple times and combining their results. A different initial seed is provided for each run of the clustering algorithm to produce different results. For example, an initial iteration of the clustering algorithm may specify the input vectors be clustered into 10 sets, while a subsequent iteration of the clustering algorithm may specify that the input vectors be clustered into 15 sets. The results of these clustering iterations are then combined into our overlapping sets.

Each cluster is represented in our preferred system as a token and is added to the collection of tokens in the system. As shown in FIG. 11, each of the 11 clusters is numbered and 11 new tokens are added.

### 1.5 Pattern Finding

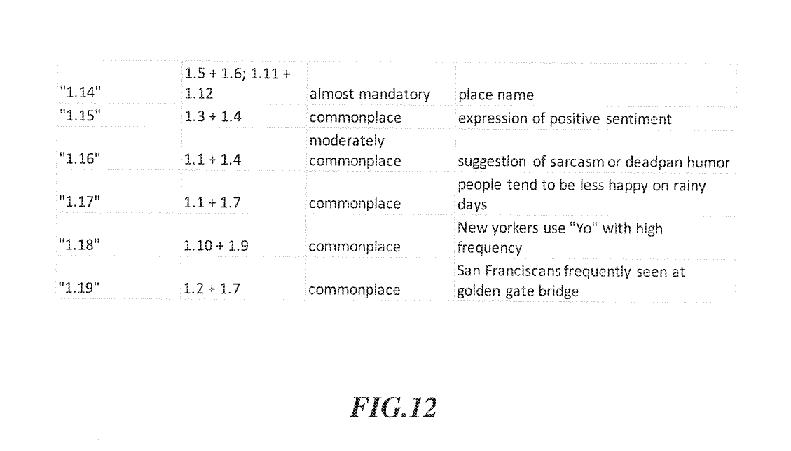

FIG. 12 illustrates pattern finding as the task of identifying a significant relationship between patterns of tokens among the collection of token sequences. The input to this step is the co-occurrence matrix. The output of pattern finding is a collection of pattern sequences mapped to their underlying element tokens.

With FIG. 11 as an example of a co-occurrence matrix, the column margin is defined as the sum of the column values, and the row margin is defined as the sum of the row values. There are two criteria for identifying a token pair as a significant pattern:

1) (co-occurrence entry/sum of all entries)>(row margin/sum of all entries)×(column margin/sum of all entries)

2) co-occurrence entry>a corpus wide tuning parameter.

The rationale behind the first criterion is to identify patterns of significance which stand out across those two tokens. The second criterion distinguishes patterns of significance from background noise.

The finding of token pairs is performed iteratively and until no additional patterns are identified. As patterns are identified, they are represented by tokens and added to the collection of tokens in the system. As successive iterations are performed, transitive relationships spanning multiple patterns will also be identified. For example, for the token sequence ABC, if AB and BC are identified as patterns of significance, the resulting pattern AC can be identified as a possible pattern to be checked for significance.

it is important to note that these token sequence relationships extend beyond adjacent token pairs. For the token sequence WXYZ, the token pattern WZ skips across the token pattern XY in between. This ability to skip across token patterns is analogous to skip-grams which cross intermediate tokens.

### 1.6 Trimming

The purpose of trimming is to remove (or block) unnecessary tokens from propagating, out of the current layer. This step prevents low value abstractions from being included in the output of a layer. An analogy to low value abstractions blocked by the trimming step is found in the field of document abstraction, where words with no predictive value are referred to as stop words (e.g. “the”). The codification of stop words is a standard practice for document abstraction systems, but this is not required in our LVCPT system.

Trimming prevents unnecessary tokens from propagating out of the current LVCPT layer. Too many tokens will slow down the performance of the system, causing it to devote too many resources to a combinatorially exploding question. For these reasons, it is necessary to limit which tokens continue to the next layer.

There are two criteria for trimming tokens:

1) very frequently occurring tokens.

2) the value of the meaning vector lies close to the value of the meaning vector for a pattern or cluster containing it.

The rationale for the first criterion is that very frequently occurring tokens are typically stop words, which have a low predictive value (e.g. “the”). The second criterion identify tokens which don't carry substantial non-redundant information.

What is claimed is:

1. A system and method using a layered, auto-regression architecture to abstract sporadic, heterogeneous, multimodal, unlabeled, unstructured, sequential data.

2. A system and method using an auto-regression architecture to abstract unlabeled data comprising a layered approach using co-occurrence matrix generation, vectoring, clustering, pattern finding, and trimming techniques combined together to yield relevant abstractions of unlabeled data.

3. A system and method using a deep machine learning architecture to abstract unlabeled data, comprising a layered approach using vectoring, clustering, pattern finding, and trimming techniques combined in that order to yield relevant abstractions of unlabeled data.

4. A system and method using a deep machine learning architecture to abstract unlabeled data, comprising a layered approach using co-occurrence matrix generation, vectoring, clustering, pattern finding, and trimming techniques combined in that order to yield relevant abstractions of unlabeled data.
